(19) United States
(12) Patent Application Publication
(10) Pub. No.: US 2021/0342301 A1
(43) Pub. Date: Nov. 4, 2021

(54) FILESYSTEM MANAGING METADATA OPERATIONS CORRESPONDING TO A FILE IN ANOTHER FILESYSTEM

(71) Applicant: Hewlett Packard Enterprise Development LP, Houston, TX (US)

(72) Inventors: Venkataraman Kamalaksha, Bangalore Karnataka (IN); Suparna Bhattacharya, Bangalore Karnataka (IN); Ashutosh Kumar, Bangalore Karnataka (IN)

(21) Appl. No.: 17/249,907

(22) Filed: Mar. 18, 2021

(30) Foreign Application Priority Data
Apr. 29, 2020 (IN) 202041018421

(51) Int. Cl. G06F 16/14; G06F 16/16; G06F 16/178; G06F 16/188

(52) U.S. Cl. CPC G06F 16/148; G06F 16/188; G06F 16/178; G06F 16/164

(57) ABSTRACT

Examples described herein relate to a computing system, a method and a non-transitory machine-readable medium for handling a request directed to a file in first filesystem having a filesystem instance being a content addressable storage objects. The computing system may also include a general-purpose second filesystem including its backing store within the filesystem instance of the first filesystem. Moreover, the computing system includes a first filesystem server to receive the request for an operation directed to the file in the first filesystem from an application. The first filesystem server may redirect the request to the second filesystem if the operation is a metadata operation; else redirect the request to the first filesystem.

### BACKGROUND

Computing systems may be connected over a network and may be used for various purposes, including processing, analysis, and storage. Computing systems may operate data virtualization platforms that control how data is stored.

### BRIEF DESCRIPTION OF THE DRAWINGS

These and other features, aspects, and advantages of the present specification will become better understood when the following detailed description is read with reference to the accompanying drawings in which Ike characters represent like parts throughout the drawings, wherein:

FIG. 1 depicts a computing system including a first filesystem and a second filesystem integrated with the first filesystem, in accordance with an example;

FIG. 2 depicts a filesystem instance of the first filesystem of FIG. 1, in accordance with an example;

FIG. 3 is a flow diagram depicting a method for handling a request directed to a first filesystem, in accordance with an example;

FIG. 4 is a flow diagram depicting a method for handling a request directed to a first filesystem, in accordance with another example;

FIG. 5 is a flow diagram depicting a method for synchronizing identifiers of a file object tree and a file metadata object tree, in accordance with an example; and

FIG. 6 is a block diagram depicting a processing resource and a machine-readable medium encoded with example instructions to handle a request directed to a first filesystem, in accordance with an example.

It is emphasized that, in the drawings, various features are not drawn to scale. In fact, in the drawings, the dimensions of the various features have been arbitrarily increased or reduced for clarity of discussion.

### DETAILED DESCRIPTION

The following detailed description refers to the accompanying drawings. Wherever possible, same reference numbers are used in the drawings and the following description to refer to the same or similar parts. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

The terminology used herein is for the purpose of describing particular examples and is not intended to be limiting. As used herein, the singular forms “a,” “an,” and “the” are intended to include the plural forms as well, unless the context clearly indicates otherwise, The term “another,” as used herein, is defined as at least a second or more. The term “coupled,” as used herein, is defined as connected, whether directly without any intervening elements or indirectly with at least one intervening element, unless indicated otherwise. For example, two elements can be coupled mechanically, electrically, or communicatively linked through a communication channel, pathway, network, or system.

Further, the term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

Data may be stored on a computing system, such as, a server, a storage array, a cluster of servers, a computer appliance, a workstation, a storage system, a converged system, a hyperconverged system, or the like. In some example converged or hyper-converged storage systems, physical storage media, such as, storage disks and/or solid-state drive (SSD) memory devices, may be abstracted into virtual volumes (alternatively also referred to as virtual disks) via a data virtualization platform. The virtual volumes may be exposed to applications running on the computing system as Logical Unit Numbers (LUNs).

Typically, a filesystem may facilitate file management operations and may allow clients to access the virtual disks for various file storage applications using one or more file access protocols, such as, a Server Message Block (SMB) protocol, a Network Filesystem (NFS) protocol, and a File Transfer Protocol (FTP), and Object Access API protocols such as a Representational State Transfer (REST) Application Programming Interface (API). The filesystem may control how files are stored and retrieved from an underlying virtual disk. The filesystem may be transparently constructed from one or multiple virtual volumes and may be a unit for replication and disaster recovery for the file management system.

Some example filesystems are designed to serve virtual disks to virtual machines, For example, such a filesystem may efficiently carve-out virtual volumes from a physical storage media in a computing system and may also provide built-in de-duplication using content addressable objects. Unlike a traditional general-purpose filesystem, files in such a specialized filesystem may typically represent virtual disks, which may be exposed as block devices to guest virtual machines. For example, in a VMware environment, such filesystem may be exposed as an NFS data store to a hypervisor, and store VMDK (virtual machine disk) files for each guest virtual machine (VM) hosted on this data store. The guest VM may then install a local filesystem or a general-purpose filesystem (e.g., ext4 or xfs) on this virtual disk.

The example filesystem mentioned hereinabove may store a filesystem instance containing files corresponding to all the virtual disks associated with a VM. Typically, the example filesystem may be optimized to contain a number of large (virtual disk) files. Consequently, in the example filesystem, operations such as directory namespace and file metadata operations may not be optimized and the maximum number of inodes (e.g., files) in the filesystem instance may be limited. Due to such design and implementation level tradeoffs, use of the example filesystem as a general-purpose filesystem may be challenging.

Accordingly, a computing system is presented that includes a first filesystem having a filesystem instance being a content addressable storage objects. The computing system may also include a general-purpose second filesystem including a backing store. The backing store of the second filesystem is stored within the filesystem instance of the first filesystem. Moreover, the computing system may include a first filesystem server communicatively coupled to the first filesystem and the second filesystem. The first filesystem server may receive a request for an operation directed to a file in the first filesystem from an application, and redirect the request to the second filesystem if the operation is a metadata operation, else redirect the request to the first filesystem.

As will be appreciated, in such example computing system, the first filesystem may be a filesystem that can efficiently manage data operations and can handle large files with built-in de-duplication features and the second filesystem may be a general-purpose filesystem that can manage metadata operations efficiently. Advantageously, such a hybrid first filesystem can lead to efficient handling of both data and metadata operations. Further, such hybrid filesystem may be exposed directly as an NFS filesystem to applications for file oriented use cases, without restricting functionality or performance. Furthermore, such hybrid filesystem, in some examples, may enable Read-Write-Many (RWM) shared persistent volumes for containers. Moreover, the hybrid filesystem may facilitate a similar level of consistency, high-availability, cloning, and backup/restore for the filesystem instance as provided by the independent first filesystem. Additionally, maintaining the backing store that is used to manage the metadata operations within the same filesystem instance that manages data operations allows for consistent backup and restore of file data and namespace/metadata data.

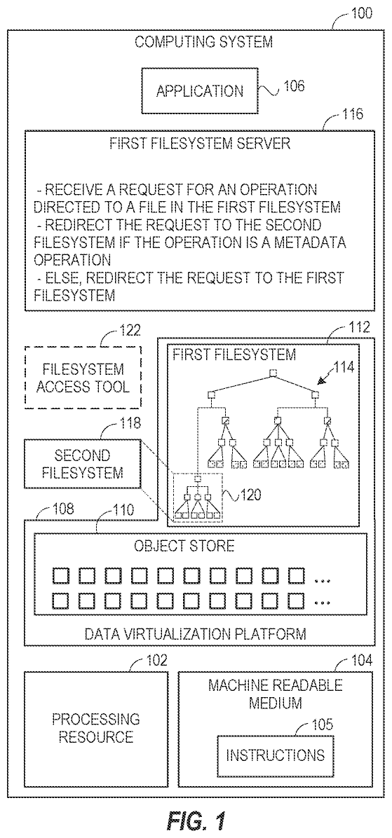

Referring now to the drawings, in FIG. 1, a computing system 100 including a first filesystem and a second filesystem integrated with the first filesystem is presented, in accordance with an example. In some examples, the computing system 100 may be a device including a processor or microcontroller and/or any other electronic component, or a device or system that may facilitate various compute and/or data storage services, for example. Examples of the computing system 100 may include, but are not limited to, a desktop computer, a laptop, a smartphone, a server, a computer appliance, a workstation, a storage system, or a converged or hyperconverged system, and the like. In some examples, the computing system 100 may include a processing resource 102 and a machine-readable medium 104.

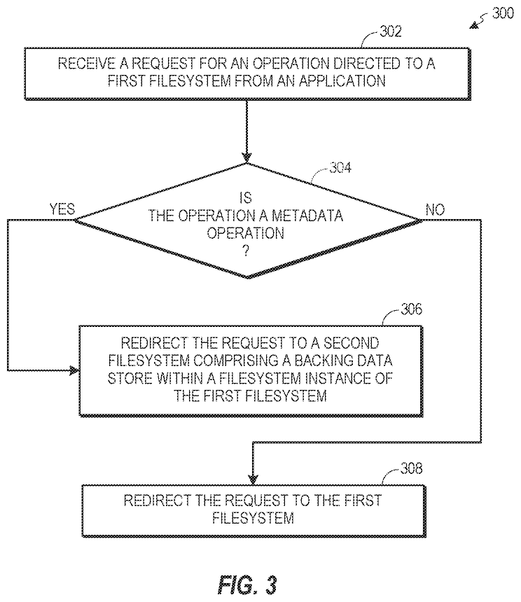

The machine-readable medium 104 may be any electronic, magnetic, optical, or other physical storage device that may store data and/or executable instructions 105. For example, the machine-readable medium 104 may be a Random Access Memory (RAM), an Electrically Erasable Programmable Read-Only Memory (EEPROM), a storage drive, a flash memory, a Compact Disc Read Only Memory (CD-ROM), and the like. The machine-readable medium 104 may be non-transitory. As described in detail herein, the machine-readable medium 104 may be encoded with executable instructions 105 to perform one or more methods, for example, methods described in FIGS. 3-5.

Further, the processing resource 102 may be a physical device, for example, one or more central processing unit (CPU), one or more semiconductor-based microprocessors, one or more graphics processing unit (GPU), application-specific integrated circuit (ASIC), a field programmable gate array (FPGA), other hardware devices capable of retrieving and executing instructions 105 stored in the machine-readable medium 104, or combinations thereof. The processing resource 102 may fetch, decode, and execute the instructions 105 stored in the machine-readable medium 104 to handle requests directed to a first filesystem (described further below). As an alternative or in addition to executing the instructions 105, the processing resource 102 may include at least one integrated circuit (IC), control logic, electronic circuits, or combinations thereof that include a number of electronic components for performing the functionalities intended to be performed by a first filesystem server (described further below).

In some examples, the computing system 100 may host an application 106 which may be run using resources (e.g., the processing resource 102 and the machine-readable medium 104). Although, the application 106 is shown as being hosted on the computing system 100, the application 106 may be an application hosted on any other computing system coupled to the computing system 100 over a network. Examples of the application 106 may include any computer program, a virtual machine, software patch, a container, a containerized application, and the like. During operation, the application 106 may issue several requests to access various files stored in the computing system 100.

Further, the computing system 100 may include a data virtualization platform 108. The data virtualization platform 108 may create a virtualized storage (e.g., virtual volumes or virtual disks) that may include aspects (e.g., addressing, configurations, etc.) abstracted from data stored in a physical storage of the computing system 100. The data virtualization platform 108 may be presented to a user environment (e.g., to the application 106, an operating system, other user applications, processes, etc.) hosted on the computing system 100 and outside of the computing system 100 with access permissions. In some examples, the data virtualization platform 108 may present virtual volumes to the user environment as one or more LUNs (not shown). Further, in some examples, the data virtualization platform 108 may also provide data services such as deduplication, compression, replication/cloning, and the like. The data virtualization platform 108 may be created and maintained on the computing system 100 by the processing resource 102 of the computing system 100 executing software instructions 105 stored on the machine-readable medium 104 of the computing system 100.

The data virtualization platform 108 may include an object store 110. The object store 110 may store objects (represented via square boxes inside the object store 110), including data objects and metadata objects. A file at the file protocol level (e.g., user documents, a computer program, etc.) may be made up of multiple objects within the data virtualization platform 108. The objects of the object store 110 may be identifiable by content-based signatures. The signature of an object may be a cryptographic digest of the content of that object, obtained using a hash function including, but not limited to, SHA-1, SHA-256, or MD5, for example.

Further, the objects of the object store 110 in the data virtualization platform 108 may be hierarchically arranged in a filesystem, for example, a first filesystem 112. The first filesystem 112 may control how files are stored and retrieved via the objects stored the object store 110. Furthermore, the first filesystem 112 can store files with varying sizes (i.e., file sizes ranging from a few Kilobytes to a few Gigabytes). For example, the first filesystem 112 can also store and manage number of large files, such as, files pertaining to a virtual machine (e.g., VMDK files), The first filesystem 112 may be transparently constructed from one or multiple virtual volumes and may be a unit for replication and disaster recovery in the data virtualization platform 108. In some examples, the first filesystem 112 may facilitate file management operations and may allow clients (e.g., the application 106) to access the virtual volumes for various file storage applications via one or more file access protocols, such as. an SMB protocol, an NFS protocol, an FTP, and Object Access API protocols such as REST API. Further, in certain examples, the first filesystem 112 may also implement features such as de-duplication and compression using content addressable objects.

In some examples, the hierarchical arrangement of the objects in the first filesystem 112 may be referred to as a filesystem instance or a hive. For illustration purpose, the data virtualization platform 108 is shown to include one such filesystem instance 114. In particular, the filesystem instance 114 may represent a hierarchical arrangement of at least some of the objects stored in the object store 110. It is understood that, in some examples, the first filesystem 112 may also include additional filesystem instances without limiting the scope of the present disclosure.

Further, in some examples, the data virtualization platform 108 may export a file protocol mount point (e.g., an NFS or an SMB mount point) by which an operating system on the computing system 100 can access the storage provided by the filesystem instance 114 via a namespace of the file protocol mount point. In some examples, such file protocol mount functionality may be facilitated by a first filesystem server 116. In some examples, the first filesystem server 116 may include, for example, hardware devices including electronic circuitry for implementing the functionality described herein. In addition or as an alternative, the first filesystem server 116 may be implemented as a series of instructions 105 encoded on the machine-readable storage medium 104 of computing device 100 and executable by the processing resource 102. In some examples, the first filesystem server 116 may provide access to the first filesystem 112 via file access protocols including, but not limited to, the SMB protocol, the NFS protocol, the FTP, and the REST API.

Moreover, the first filesystem 112 may be a hybrid filesystem in which another filesystem, for example, a second filesystem 118 may be integrated. In some examples, the second filesystem 118 hosted on the computing system 100 may be a general-purpose filesystem which can manage metadata operations efficiently. Examples of the second filesystem 118 may include, but are not limited to, exFAT, ext4, FAT (e.g., FAT12, FAT16, FAT32), NTFS, ext2, ext3, XFS, btrfs, Files-11, and the like. In accordance with aspects of the present disclosure, the second filesystem 118 may be integrated with the first filesystem 112, and the first filesystem server 116 may use the second filesystem 118 to manage various metadata operations intended for the first filesystem 112.

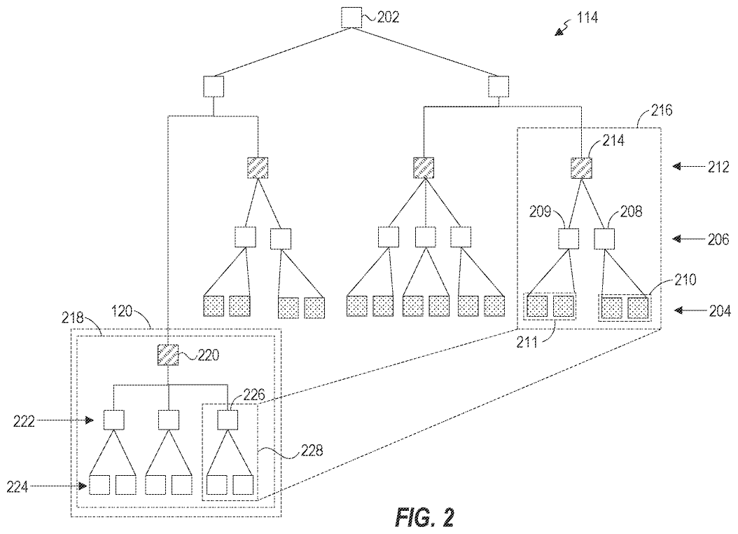

The second filesystem 118 may be integrated with the first filesystem 112 such that a backing store 120 of the second filesystem 118 may be formed within the first filesystem 112. As such, the backing store 120 may cause the integration of the second filesystem 118 with the first filesystem 112. In particular, the backing store 120 may be formed within the filesystem instance 114, The backing store 120 may be used by the second filesystem 118 to handle various metadata operations (described later) directed to first filesystem 112. Additional details regarding the filesystem instance 114 having the backing store 120 of the second filesystem 118 will be described in conjunction with FIG. 2, For ease of illustration, description of FIG. 2 is integrated with FIG. 1.

FIG. 2 depicts the filesystem instance 114, in accordance with an example. In FIG. 2, one or more objects in the filesystem instance 114, may be related to a root object 202 in an object tree (e.g., a Merkle tree, as depicted in FIG. 2) or any other hierarchical arrangement (e.g., directed acyclic graphs, etc.). The root object 202 may store, as its content, a signature that may identify the entire filesystem instance 114 at a point in time. In some examples, an identifier of the root object 202 may be referred to as an identifier of the filesystem instance 114. The root object 202 may be an object from which metadata objects and data objects relate hierarchically. The number of branches and levels in the filesystem instance 114 are for illustration purposes only. Greater or fewer number of branches and levels may exist in other example filesystem instances. Also, in some examples, subtrees may have different numbers of levels.

In some examples, the lowest level object(s) of any branch (that is, most distant from the root object) may be data objects 204 (e.g., the objects filled with a dotted pattern) that represent user data. Further, objects at a level above the data objects 204 may be metadata objects 206 (also referred to as leaf metadata objects 206) containing signatures of the respective data objects 204. For example, a leaf metadata object 208 may include cryptographic hash signatures of content of data objects 210.

Further, the root object 202 and internal nodes of the object tree (e.g., objects at any level above the data objects 204) may also be metadata objects that store, as content, the signatures of child objects. Any metadata object may be able to store a number of signatures that is at least equal to a branching factor of the hierarchical tree, so that it may hold the signatures of all of its child objects. In some implementations, data objects 204 may be larger in size than metadata objects 206, 214, etc. It may be noted that the objects (e.g., the data objects and the metadata objects) in the filesystem instance 114 represent or act as pointers to respective the objects in the object store 110. Content (e.g., metadata or data information) of the objects is stored in the object store 110 which may in-turn occupy storage space from a physical storage underlying the data virtualization platform 108.

Furthermore, in some examples, the objects (filled with pattern of angled lines) are referred to as file identity nodes 212 (hereinafter referred to as file inodes 212). Each of the file inodes 212 may uniquely identify a file. For example, a given file inode and downstream objects (e.g., the leaf metadata objects 206 and the data objects 204) linked to the given file inode may form a tree of objects constituting a file (e.g., user documents, a computer program, etc.). For example, a file inode 214, leaf metadata objects 208 and 209, and the data objects 210, 211 may form a file object tree 216. In some examples, the file object tree 216 may represent a file (e.g., a VMDK file corresponding to a virtual machine) that is uniquely identified by an identifier of the file inode 214. In some examples, the file inodes 212 may also be metadata objects that store cryptographic hash signatures of the leaf metadata object(s) 206 linked thereto. For example, the file inode 214 may include a cryptographic hash signature of the leaf metadata objects 208 and 209.

Additionally, in some examples, the filesystem instance 114 may also include a filesystem host file 218. The filesystem host file 218 may also be formed by a file object tree made of file inode 220 and corresponding downstream objects. The filesystem host file 218 may be uniquely identified by an identifier of the file inode 220 and include various objects arranged in one or more levels below the file inode 220. In some examples, the filesystem host file 218 may form a part of the backing store 120 of the second filesystem 118 and the file inode 220 may serve as a root node for the backing store 120.

In the backing store 120, the second filesystem 118 may maintain metadata objects arranged in various file metadata trees corresponding to files stored in the filesystem instance 114 and the second filesystem 118 may carry out certain metadata operations using the backing store 120. In particular, the backing store 120 may include a file metadata object tree corresponding to each file managed by the first filesystem 112 in the filesystem instance 114. File metadata identifier objects 222 and metadata objects 224 may form various file metadata trees (e.g., three file metadata objects trees are shown within the backing store 120). Further, it may be noted that, in the example of FIG. 2, the backing store 120 (e.g., the filesystem host file 218) is shown to include the metadata objects arranged in two levels below the file inode 220 for illustration purposes. As the size of metadata information grows, more metadata objects and/or tree levels may be added in the backing store 120.

By way of example, a file metadata identifier object 226 and the metadata objects 224 linked thereto may form a file metadata object tree 228, In one example, the file metadata object tree 228 may correspond to a file represented by the file object tree 216. Accordingly, data information corresponding to a given file (e.g. the file represented by the file object tree 216) may be maintained in data objects 210, 211 arranged under the file object tree 216 outside of the backing store 218, and metadata information corresponding to the given file may be maintained in the metadata objects 224 arranged in the file metadata object tree 228 within the backing store 218. Further, in order to define a relationship between the file object trees in the filesystem instance 114 and the file metadata trees in the backing store 218, identifiers of related file object trees and the file metadata object trees may be synchronized by the first filesystem server 116 (described further below). For example, first filesystem server 116 may keep identifiers of the file inode 214 and identifier of the file metadata identifier object 226 synchronized. In particular, in certain examples, the identifiers of the file inode 214 and the file metadata identifier object 226 are kept identical.

Referring again to FIG. 1, in some examples, the first filesystem server 116 may create the filesystem host file 218 within the filesystem instance 114 and assign the filesystem host file 218 to the second filesystem 118 as the backing store 120. In some examples, the first filesystem server 116 may create more than one such filesystem host files within the filesystem instance 114 and assign those to the second filesystem 118 as the backing store 120. Accordingly, in some examples, the backing store 120 may include more than one filesystem host files. In the description hereinafter, for ease of illustration, the backing store 120 is described as having the filesystem host file 218 from the filesystem instance 114.

Additionally, in certain examples, the computing system 100 may optionally include a filesystem access tool 122 accessible by the first filesystem server 116 to aid in communication with the second filesystem 118. In one example, the filesystem access tool 122 may be an NFS server that can allow access to the second filesystem 118. In another example, the filesystem access tool 122 may be an API interface compatible with the second filesystem 118 by which the first filesystem server 116 can communicate with the second filesystem 118.

The first filesystem server 116 may be communicatively coupled to the first filesystem 112 and the second filesystem 118. The first filesystem server 116 may be communicatively coupled to the second filesystem 118 directly or via the filesystem access tool 122. During operation of the computing system 100, the first filesystem server 116 may handle incoming requests directed to the first filesystem 112 using one or both of the first filesystem 112 and the second filesystem 118. For example, the first filesystem server 116 may receive a request for an operation directed to a file (e.g., the file represented by the file object tree 216) in the first filesystem 112 from an application, for example, the application 106.

In some examples, the first filesystem server 116 may redirect the request to the second filesystem 118 if the operation is a metadata operation. In some examples, the first filesystem server 116 may directly communicate with the second filesystem 118. In certain other examples, the first filesystem server 116 may redirect the request to the second filesystem 118 via the filesystem access tool 122. However, if the operation is not the metadata operation, i.e., the operation is data read or write operation, the first filesystem server 116 may redirect the request to the first filesystem 112. Details of various operations performed by the first filesystem server 116 will be described in conjunction with methods described in FIGS, 3-5.

As will be appreciated, in such example computing system 100, the first filesystem 112 may be a filesystem that can efficiently manage data operations and can handle large files with built-in de-duplication features and the second filesystem 118 may be a general-purpose filesystem that can manage metadata operations efficiently. Advantageously, such first filesystem 112 (alternatively also referred to as a hybrid first filesystem 112) can lead to efficient handling of both data and metadata operations. Further, such hybrid filesystem 112 may be exposed directly as an NFS filesystem to applications for file oriented use cases, without restricting functionality or performance. Furthermore, such hybrid filesystem, in some examples, may enable Read-Write-Many (RWM) shared persistent volumes for containers. Moreover, the hybrid filesystem 112 may facilitate a similar level of consistency, high-availability, cloning, and backup/restore for the filesystem instance 114 as that of the independent first filesystem 112. Additionally, maintaining the backing store 120 that is used to manage the metadata operations within the same filesystem instance 114 that manages data operations may provide for consistent backup and restore of file data and namespace/metadata data.

Referring now to FIG. 3, a flow diagram depicting a method 300 for handling a request directed to the first filesystem 112 is presented, in accordance with an example. For illustration purposes, the method 300 will be described in conjunction with the computing system 100 of FIG. 1. The method 300 may include method blocks 302, 304, 306, and 308 (hereinafter collectively referred to as blocks 302-308) which may be performed by a processor based system, for example, the first filesystem server 116. In particular, operations at each of the method blocks 302-308 may be performed by the processing resource 102 by executing the instructions 105 stored in the machine-readable medium 104 (see FIG. 1).

At block 302, the first filesystem server 116 may receive a request for an operation directed to a file (e.g., the file represented by the file object tree 216) in the first filesystem 112 from an application (e.g., the application 106). The operation requested in the request may be any of a data operation or a metadata operation. For example, the data operation may be a data read operation or a data write operation; and the metadata operation may be a directory create operation (e.g., mkdir operation), a file create operation (e.g., create operation), a file lookup operation (e.g., create operation), a directory read operation (e.g., readdir operation, alternatively also referred as a directory entry read operation), a file rename operation (e.g., rename operation), a set attribute operation (e.g., setattr operation), or a read attribute operation (e.g., getattr operation), or the like.

Further, at block 304, the first filesystem server 116 may perform a check to determine whether the operation is a metadata operation. In some examples, determining whether the operation is the metadata operation at block 304 may include comparing, by the first filesystem server 116, the operation against a predetermined list of metadata operations (hereinafter referred to as a list of metadata operations). The list of metadata operations may be maintained in the machine readable medium 104 that may be customized by a user (e.g., administrator) to add any new metadata operations and/or remove any entry from the list of the metadata operations. In some examples, the list of metadata operations may include operations such as, but not limited to, the directory create operation, the file create operation, the file lookup operation, the directory read operation, the file rename operation, the set attribute operation, or the read attribute operation. If the operation requested in the request is identified to be any of the operation contained in the list of the metadata operations, the first filesystem server 116 may determine that the operation is the metadata operation. However, if the operation requested in the request is not identified in the list of the metadata operations, the first filesystem server 116 may determine that the operation is not metadata operation. In such case, the operation may be a data operation, for example, a read or a write operation.

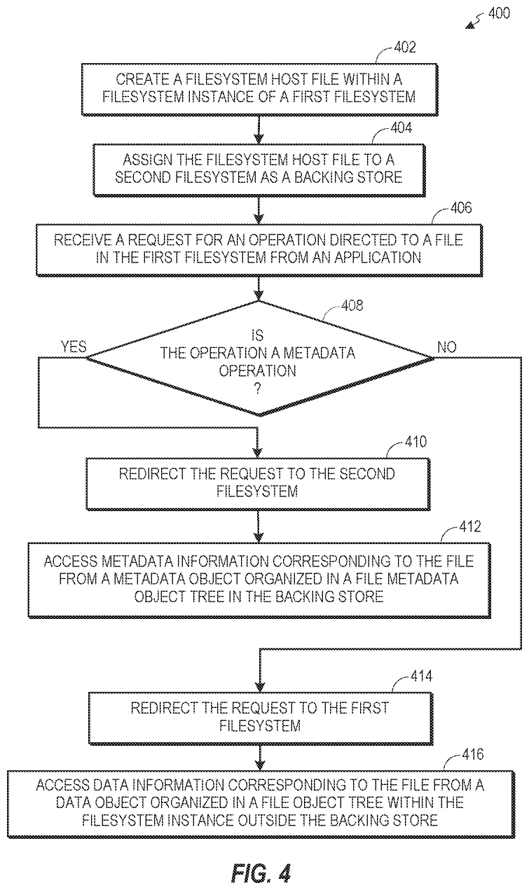

At block 304. if it is determined that the operation is the metadata operation, at block 306, the first filesystem server 116 may redirect the request to the second filesystem 118. Upon receipt of the request, the second filesystem 118 may address the metadata operation by accessing the backing store 120 (described in greater detail in FIG. 4). Further, at block 304, if it is determined that the operation is not the metadata operation (i.e., the operation is the data operation), at block 308, the first filesystem server 116 may redirect the request to the first filesystem 112. Upon receipt of the request, the first filesystem 112 may address the data operation by accessing the filesystem instance 114 (described in greater detail in FIG. 4).

Moving now to FIG. 4, a flow diagram depicting a method 400 for handling a request directed to a file in the first filesystem 112 is presented, in accordance with another example. For illustration purposes, the method 400 will be described in conjunction with the system 100 of FIG. 1. The method 400 may include method blocks 402, 404, 406, 408, 410, 412, 414, and 416 (hereinafter collectively referred to as blocks 402-416), at least some of which may be performed by a processor based system, for example, the first filesystem server 116. In particular, operations at the method blocks 402-416 may be performed by the processing resource 102 by executing the instructions 105 stored in the machine-readable medium 104 (see FIG. 1). The method 400 includes certain method blocks that are similar to ones described in FIG. 3. description of which is not repeated herein. For example, the blocks 406, 408, 410, and 414 of the method 400 are similar to the blocks 302, 304, 306, and 308, respectively, of the method 300.

At block 402, the first filesystem server 116 may create a filesystem host file, for example, the filesystem host file 218 (see FIG. 2) within the first filesystem 112. In some examples, the creating the filesystem host file 218 may include defining the file inode 220 as a root node (or originating node) for the filesystem host file 218. Further, at block 404, the first filesystem server 116 may assign the filesystem host file 218 to the second filesystem 118 as the backing store 120. Accordingly, in some examples, the filesystem host file 218 may act as the backing store 120 for the second filesystem 118. Alternatively, in certain examples, the filesystem host file 218 may form at least a portion of the backing store 120. In some examples, the first filesystem server 116 may perform operations at blocks 402, 404 to set-up the backing store 120. The setting-up of the backing store 120 via blocks 402, 404 may be a one-time process and may be performed in advance of receiving the request directed to the file in the first filesystem 112 at block 406. In case more space is required, the first filesystem server 116 may dynamically add additional filesystem host files to the backing store 120. As previously noted, the backing store 120 maintains metadata objects 224 managed by the second filesystem 118 corresponding to various files of the first filesystem 112. Such metadata objects 224 may be arranged in various file metadata object trees (e.g., the file metadata object tree 228).

Further, at block 406, the first filesystem server 116 may receive a request for an operation directed to a file (e.g., the file represented by the file object tree 216). Furthermore, at block 408, the first filesystem server 116 may perform a check to determine whether the operation is a metadata operation. If it is determined at block 408 that the operation is the metadata operation, at block 410, the first filesystem server 116 may redirect the request to the second filesystem 118, directly or via the filesystem access tool 122. In some examples, along with the request, the first filesystem server 116 may communicate, to the second filesystem 118, a file handle including information regarding which file metadata object tree to be accessed from the backing store 120 to fulfill the request. For example, if the request pertains to the file represented by the file object tree 216 in the filesystem instance 114, the file handle may include an identifier of the file metadata identifier object 226. As described earlier, the file metadata identifier object 226 identifies the file metadata object tree 228 containing metadata objects related to the file represented by the file object tree 216. In certain examples, the identifier of the file metadata identifier object 226 may be the same as the identifier of the file inode 214.

Upon receipt of the request from the first filesystem server 116, the second filesystem 118 may address the metadata operation by accessing the backing store 120. In some examples, at block 412, the second filesystem 118 may access metadata information corresponding to the file from a metadata object organized in a file metadata object tree in the backing store 120 to perform the operation. In particular, the second filesystem 118 may access the file metadata object tree whose identifier information is provided in the file handle, In the ongoing example, as the file handle includes the identifier of the file metadata identifier object 226, the second filesystem 118 may access the file metadata object tree 228. The term “access” in the context of block 412 may refer to any of reading, updating, overwriting, or deleting the metadata information presented by the objects 224 within the metadata object tree 228 and/or adding new metadata objects at same or different levels within the metadata object tree 228. For example, if the metadata operation is a file rename operation corresponding to the file represented by the file object tree 216, the second filesystem 118 may overwrite or update a metadata object containing information pertaining to the filename with a new name.

Moving back to block 408, if it is determined that the operation is not the metadata operation (i.e., the operation is a data operation), at block 414, the first filesystem server 116 may redirect the request to the first filesystem 112. In some examples, along with the request, the first filesystem server 116 may communicate, to the first filesystem 112, a file handle including information regarding which file object tree to be accessed from the filesystem instance 114 fulfill the request. For example, if the request pertains to the file represented by the file object tree 216, the file handle may include an identifier of the file inode 214. As described earlier, the file inode 214 identifies the file object tree 216 containing the data objects 210, 211 related to the file represented by the file object tree 216.

Upon receipt of the request from the first filesystem server 116, the first filesystem 112 may address the data operation by accessing the filesystem instance 114. In some examples, at block 416, the first filesystem 112 may access data information corresponding to the file from a data object organized in a file object tree in the filesystem instance 114 to perform the operation. In particular, the first filesystem 112 may access the file object tree whose identifier information is provided in the file handle. In the ongoing example, as the file handle includes the identifier of the file inode 214, the first filesystem 112 may access the file object tree 216. The term “access” in the context of block 416 may include any of reading, updating, overwriting, or deleting the data information presented by the objects 210, 211 within the fie object tree 216 and/or adding new data objects at same or different levels within the file object tree 216. For example, if the data operation is a read operation corresponding to the file represented by the file object tree 216, the first filesystem 112 may read relevant data object(s) from the data objects 210, 211 in the file object tree 216 and return the read data to the first filesystem server 116.

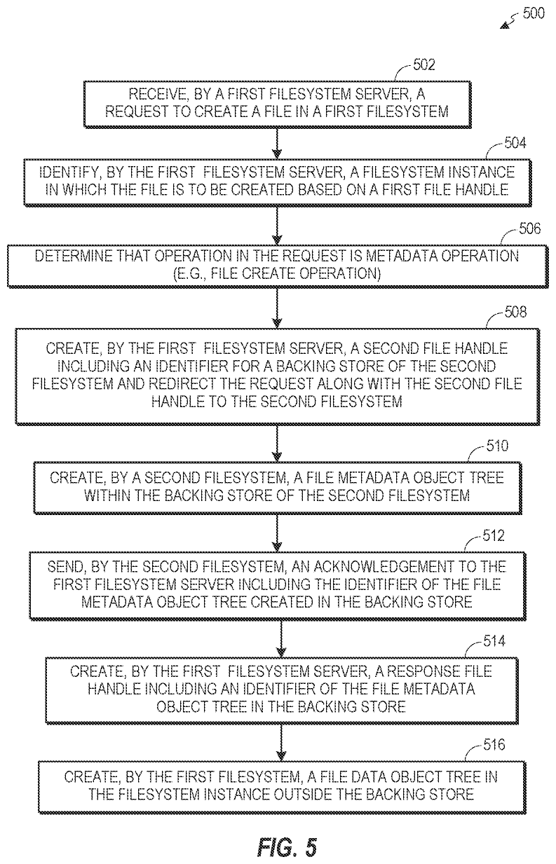

In some examples, the synchronization between the identifiers of respective file metadata objet trees within the backing store 120 and the file objet trees outside of the backing store 120 is a key to provide access to relevant data and metadata information despite of using two different filesystems to address the request, In some examples, the first filesystem server may synchronize an identifier of a file object tree with an identifier of the file metadata object tree by generating various file handles for the first filesystem and the second filesystems (see FIG. 5, for example). FIG. 5 is a flow diagram depicting an example method for synchronizing the identifiers of a file object tree and a file metadata object tree. For illustration purposes, the method 500 will be described in conjunction with the system 100 of FIG. 1. The method 500 may include method blocks 502, 504, 506, 508, 510, 512, 514, and 516 (hereinafter collectively referred to as blocks 502-516), may be performed by the processing resource 102 by executing the instructions 105 stored in the machine-readable medium 104 (see FIG. 1).

The example method 500 describes method blocks for a file create operation. For example, at block 502, the first filesystem server 116 may receive a request to create a file in the first filesystem 112. In some examples, the request may include a first file handle including information about an identifier of a filesystem instance in which the file is to be created. For example, the identifier of the filesystem may be an identifier of the file system instance 114 (e.g., the identifier of the root object 202). At block 504, the first filesystem server 116 may identify the filesystem instance in which the file is to be created based on the first file handle. For example, based on the information in the first file handle, it may be determined that the filesystem instance in which the file is to be created is the filesystem instance 114. At block 506, the first filesystem server 116 may determine that the operation is the metadata operation (e.g., a file create operation).

Further, at block 508, the first filesystem server 116 may create a second file handle including an identifier for the backing store 120 (e.g., the identifier of the object 220) of the second filesystem 118 and redirect the request to the second filesystem 118 (directly or via the filesystem access tool 122) along with the second file handle. Accordingly, at block 510, the second filesystem 118 may create a metadata object tree within the backing store 120 based on the information in the second file handle. In particular, the metadata object tree with a metadata identifier object 222 and at least one metadata object 224 may be created in the filesystem host file 218. The created metadata object tree may be identified by an identifier of its metadata identifier object 222.

In some examples, once the metadata object tree is created, at block 512, the second filesystem 118 may send an acknowledgement to the first filesystem server 116 including the identifier of the file metadata object tree created in the backing store 120. In particular, the second filesystem 118 may send the identifier of the metadata identifier object 222 corresponding to the created metadata object tree. Further, at block 514, the first filesystem server 116 may create a response file handle including the identifier of the file metadata object tree created in the backing store 120 (e.g., the identifier of the metadata identifier object 222).

Accordingly, at block 516, the first filesystem 112 may create a file, for example, a file object tree in the filesystem instance 114 outside of the backing store 120 using the identifier of the file metadata object tree contained in the response handle, The file object tree may be identified by its file inode. In some examples, the when creating the file object tree in the filesystem instance 114 outside of the backing store 120 an identifier of its file inode 212 may be maintained same as that of the identifier of the file metadata object tree received in the response file handle. Advantageously, use of such synchronized/common identifiers of related file metadata object trees within the backing store 120 of the second filesystem 118 and the file object trees outside of the backing store 120 in the first filesystem 112 may aid in easily locating and accessing files for various operations, In some examples, the operation of creating the file object tree at block 516 may be carried-out upon receipt of any data operation (e.g., write) operation for the file.

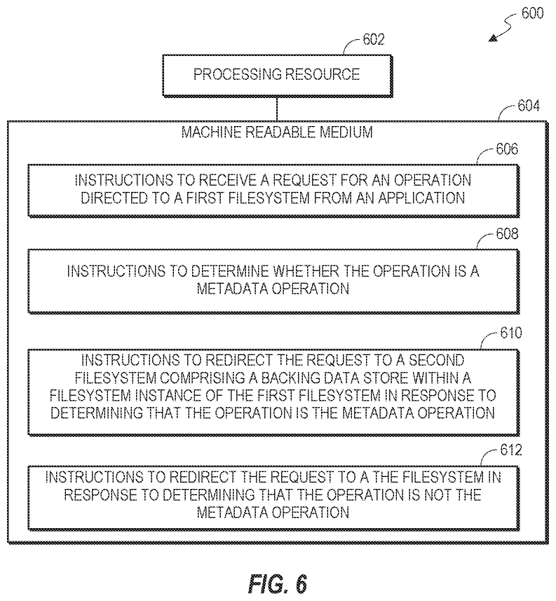

Moving to FIG. 6, a block diagram 600 depicting a processing resource 602 and a machine-readable medium 604 encoded with example instructions to handle a request directed to the first filesystem 112 is presented, in accordance with an example, The machine-readable medium 604 may be non-transitory and is alternatively referred to as a non-transitory machine-readable medium 604. In some examples, the machine-readable medium 604 may be accessed by the processing resource 602. In some examples, the processing resource 602 may represent one example of the processing resource 102 of the computing system 100 of FIG. 1. Further, the machine-readable medium 604 may represent one example of the machine-readable medium 104 of the computing system 100 of FIG. 1.

The machine-readable medium 604 may be any electronic, magnetic, optical, or other physical storage device that may store data and/or executable instructions. Therefore, the machine-readable medium 604 may be, for example, RAM, an EEPROM, a storage drive, a flash memory, a CD-ROM, and the like. As described in detail herein, the machine-readable medium 604 may be encoded with executable instructions 606, 608, 610, and 612 (hereinafter collectively referred to as instructions 606-612) for performing the method 300 described in FIG. 3. Although not shown, in some examples, the machine-readable medium 604 may be encoded with certain additional executable instructions to perform the method 400 of FIG. 4, the method 500 of FIG. 5, and/or any other operations performed by the first filesystem server 116, the first filesystem 112, and the second filesystem 118, without limiting the scope of the present disclosure,

The processing resource 602 may be a physical device, for example, one or more CPU, one or more semiconductor-based microprocessor, one or more GPU, ASIC, FPGA, other hardware devices capable of retrieving and executing the instructions 606-612 stored in the machine-readable medium 604, or combinations thereof. In some examples, the processing resource 602 may fetch, decode, and execute the instructions 606-612 stored in the machine-readable medium 604 to handle requests directed to a file in the first filesystem 112. In certain examples, as an alternative or in addition to retrieving and executing the instructions 606-612, the processing resource 602 may include at least one IC, other control logic, other electronic circuits, or combinations thereof that include a number of electronic components for performing the functionalities intended to be performed by the first filesystem server 116 of FIG. 1.

The instructions 606 when executed by the processing resource 602 may cause the processing resource 602 to receive a request for an operation directed to a file (e.g., the file represented by the file object tree 216, see FIG. 2) in the first filesystem 112 from the application 106. Further, the instructions 608 when executed by the processing resource 602 may cause the processing resource 602 to determine whether the operation is a metadata operation. Furthermore, the instructions 610 when executed by the processing resource 602 may cause the processing resource 602 to redirect the request to the second filesystem 118 in response to determining that the operation is the metadata operation, wherein the second filesystem 118 comprises the backing store 120 within the filesystem instance 114 of the first filesystem 112. Moreover, the instructions 612 when executed by the processing resource 602 may cause the processing resource 602 to redirect the request to the first filesystem 112 in response to determining that the operation is not the metadata operation.

As will be appreciated, the computing system 100; various methods 300, 400, 500; and the non-transitory machine-readable medium 604 may enable efficient handling of both data and metadata operations in the first filesystem 112 by using an integrated second filesystem 118 for managing the metadata operations for the first filesystem 112. Further, such hybrid filesystem 112 may be exposed directly as an NFS filesystem to applications for file oriented use cases, without restricting functionality or performance. Furthermore, such hybrid filesystem, in some examples, may enable Read-Write-Many (RWM) shared persistent volumes for containers. Moreover, the hybrid filesystem may facilitate same unit of consistency, high-availability, cloning, and backup/restore for the filesystem instance 114 as the facilitated by the independent first filesystem 112, Additionally, as the backing store 120 that is used to manage the metadata operations is stored within the same filesystem instance 114 that manages data operations, backup and restore of resources using the filesystem instance 114 may be easier and efficient.

While certain implementations have been shown and described above, various changes in form and details may be made. For example, some features and/or functions that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described.

In the foregoing description, numerous details are set forth to provide an understanding of the subject matter disclosed herein. However, implementation may be practiced without some or all of these details, Other implementations may include modifications, combinations, and variations from the details discussed above. It is intended that the following claims cover such modifications and variations.

We claim:

1. A computing system comprising:
a first filesystem comprising a filesystem instance representing hierarchical arrangement of content addressable objects;
a second filesystem comprising a backing store within the filesystem instance of the first filesystem; and
a first filesystem server communicatively coupled to the first filesystem and the second filesystem, wherein the first filesystem server is to receive a request for an operation directed to a file in the first filesystem from an application, and redirect the request to the second filesystem if the operation is a metadata operation, else redirect the request to the first filesystem.

2. The computing system of claim 1, wherein the filesystem instance comprises one or more files, wherein each of the one or more files is represented as a file object tree in the filesystem instance, and wherein the backing store comprises a file of the one or more files in the filesystem.

3. The computing system of claim 1, wherein data information corresponding to the file is maintained in a data object arranged in a file object tree in the filesystem instance outside of the backing store, and metadata information corresponding to the file is maintained in a metadata object arranged in a file metadata object tree within the backing store.

4. The computing system of claim 3, wherein the first filesystem server is to synchronize an identifier of the file object tree with an identifier of the file metadata object tree by generating file handles for the first filesystem and the second filesystems.

5. The computing system of claim 1, wherein the first filesystem server is to determine whether the operation is the metadata operation based at least on a predetermined list of metadata operations.

6. The computing system of claim 1, wherein the metadata operation comprises a directory create operation, a file create operation, a file lookup operation, a directory read operation, a file rename operation, or a set attribute operation.

7. The computing system of claim 1, wherein the first filesystem server is to redirect the request to the first filesystem if the operation is a read operation or a write operation.

8. The computing system of claim 1, further comprising a filesystem access tool accessible by the first filesystem server to aid in communication with the second filesystem, wherein the first filesystem server redirects the request to the second filesystem via the filesystem access tool.

9. The computing system of claim 8, wherein the filesystem access tool is a Network Filesystem (NFS) server or a filesystem Application Programming Interface (API) compatible with the second filesystem.

10. A method, comprising:
receiving, by a first filesystem server, a request for an operation directed to a file in a first filesystem from an application, wherein the first filesystem comprises a filesystem instance representing hierarchical arrangement of content addressable objects;
determining, by the first filesystem server, whether the operation is a metadata operation;
redirecting, by the first filesystem server, the request to a second filesystem in response to determining that the operation is the metadata operation, wherein the second filesystem comprises a backing store within the filesystem instance of the first filesystem; and
redirecting, by the first filesystem server, the request to the first filesystem in response to determining that the operation is not the metadata operation.

11. The method of claim 10, further comprising:
creating, by the first filesystem server, a filesystem host file within the first filesystem, and
assigning, by the first filesystem server, the filesystem host file to the second filesystem as the backing store.

12. The method of claim 10, wherein determining whether the operation is the metadata operation comprises comparing, by the first filesystem server, the operation against a predetermined list of metadata operations.

13. The method of claim 10, wherein redirecting the request to the second filesystem comprises routing the request to the second filesystem via a Network Filesystem (NFS) server or a filesystem Application Programming Interface (API) compatible with the second filesystem.

14. The method of claim 10, further comprising accessing, upon receipt of the request by the first filesystem, data information corresponding to the file from a data object organized in a file object tree within the filesystem instance outside the backing store.

15. The method of claim 14, further comprising accessing, upon receipt of the request by the second filesystem, metadata information corresponding to the file from a metadata object organized in a file metadata object tree in the backing store, wherein an identifier of the file metadata objet tree is synchronized with an identifier of the file object tree.

16. A non-transitory machine-readable medium storing instructions executable by a processing resource, the instructions comprising:
instructions to receive a request for an operation directed to a file in a first filesystem from an application, wherein the first filesystem comprises a filesystem instance representing hierarchical arrangement of content addressable objects;
instructions to determine whether the operation is a metadata operation;
instructions to redirect the request to a second filesystem in response to determining that the operation is the metadata operation, wherein the second filesystem comprises a backing store within the filesystem instance of the first filesystem; and
instructions to redirect the request to the first filesystem from in response to determining that the operation is not the metadata operation.

17. The non-transitory machine-readable medium of claim 16, further comprising instructions to:
create a filesystem host file within the first filesystem; and
assign the filesystem host file to the second filesystem as the backing store.

18. The non-transitory machine-readable medium of claim 16, further comprising instructions to maintain data information corresponding to the file in a data object arranged in a file object tree in the filesystem instance outside the backing store and metadata information corresponding to the file is maintained in a metadata object arranged in a file metadata object tree within the backing store.

19. The non-transitory machine-readable medium of claim 18, further comprising instructions to synchronize an identifier of the file object tree with an identifier of the file metadata object tree by generating file handles for the first filesystem and the second filesystems.

20. The non-transitory machine-readable medium of claim 18, further comprising instructions to:
access, upon receipt of the request by the first filesystem, the data information from the file object tree; or
access, upon receipt of the request by the second filesystem, the metadata information from the file metadata object tree.
